(19) United States
(12) Patent Application Publication
(10) Pub. No.: US 2005/0077242 A1
(43) Pub. Date: Apr. 14, 2005

(54) Soil decontamination method

(76) Inventor: Mikael Karlsson, Bunkeflostrand (SE)

Correspondence Address: Steven S. Payne, 8027 ILIFF Drive, Dunn Loring, VA, 22027, US

(21) Appl. No.: 10/943,991

(22) Filed: Sep. 20, 2004

(30) Foreign Application Priority Data
Mar. 27, 2002 (SE) 0200964-5

(51) Int. Cl. C02F 1/42

(52) U.S. Cl. 210/638; 210/747

(57) ABSTRACT

In a method of in situ or ex situ reducing or eliminating contaminants in soil or groundwater, in which solid particles of an oxidation agent are supplied to the soil or groundwater and dissolved in water. The oxidation agent is then allowed to react with the contaminants under controlled release conditions.

### TECHNICAL FIELD

The present invention relates to the treatment of soil or groundwater contaminated with organic compounds. More specifically, the invention relates to a method of reducing or eliminating contaminants in soil or groundwater, in which a solid particles of an oxidation agent are supplied to said soil or groundwater and dissolved in water, said oxidation agent being allowed to react with said contaminants under controlled release conditions.

The invention also refers to the use of solid particles of an oxidation agent as an active component for reducing or eliminating contaminants in soil or groundwater.

### BACKGROUND OF THE INVENTION

The removal of hazardous substances from soil and ground water is a major problem in the industrialised world. Contaminants from earlier generations as well as present industrial operations, leakages and accidents can result in the dispersal of hazardous chemicals in soils, ground water and surface water. A large number of sites are now contaminated as a result of earlier disposal of hazardous waste. Old landfills containing hazardous waste, industrial sites contaminated with hazardous chemicals, polluted sediments in fjords, harbours, rivers and lakes, and areas contaminated by discharges from abandoned mines constitute a risk of serious acute and long-term contamination. At some sites, such a pollution may be a direct health risk, cause irreversible environmental damage, or mean that land is unusable for some purposes. In environmental terms, the most serious problems are the risk of further dispersal of hazardous chemicals and the risk that they may enter food chains.

Soils contaminated with hydrocarbons is one of the major problems facing companies and government agencies today since the discharged substances largely comprise aromatic and aliphatic organic compounds refined from petroleum hydrocarbons. The chemical content in petroleum products generally comprises hundreds of thousands of different organic substances. The composition may vary depending on the conditions of production, the additives used etc. The solubility of the chemical substances in water is limited, but varies considerably for each specific contaminating chemical substance. The volatility is usually estimated as high, but for certain fractions the volatility is very low. The substances have a long lifespan under anaerobic conditions in the ground and are very slowly transported away with the groundwater. However, the energy content in these substances is high, which easily allow most of the substances to react with and be decomposed by an oxidation agent, such as hydrogen peroxide._Contaminating halogenated organic substances and solvents also represent a significant carcinogenic risk. The contaminating substances are often present at the surface soil matrix, but can migrate to great depths beneath the surface of the soil, and are difficult to dispose off.

Examples of released substances into the soil and groundwater include, but are not limited to gasoline, fuel oil, motor oil, polychlorinated biphenyl (PCB), benzene, toluene, ethyl benzene and xylene.

Costs for cleanup are high and going higher. Results are slow, sometimes years are needed to see if the investment in time and money will correct the problem.

The need to identify, control and treat these release sites in a timely, cost effective and environmentally sound manner is a matter of concern throughout the world. Once a release is identified and the source of the contamination (e.g. leaking tank, broken fuel transfer line, etc.) is corrected, a remediation technology that could rapidly oxidise the gasoline components would be a very useful tool. Second only to prevention of fuel releases, rapid source treatment is the most effective way to prevent adverse, long-term impacts to groundwater resources.

When groundwater is decontaminated, it is usually pumped from underground to the surface where it is treated. The processed groundwater is then returned underground. Such a procedure is usually expensive and can require years to perform.

More recently in situ chemical oxidation techniques have been employed for the treatment organic environmental contaminants. These techniques are less costly than the ex-situ methods. Strong oxidising agents, such as sodium and potassium permanganate, oxygen, ozone, and hydrogen peroxide, are used for treating chemicals in process streams and for decontaminate sites affected by various organic chemicals. The ability of these chemicals to reduce contaminants in a matter of minutes, days and weeks as opposed to months or years for other technologies has generated interest in studying the effectiveness and impacts of their use.

For example, in U.S. Pat. No. 6,102,621 contaminants in soil and groundwater are treated by providing inorganic oxidative chemicals in granular form and adding a carrier fluid comprising a fine-grained inorganic hydrophilic material. The oxidative inorganic chemicals remain in the granular form until applied by injection through an injection well into subsurface soils. The small granular size of the particulate oxidative chemicals allows the particles to remain as a slurry of solids suspended in the carrier fluid. The method is intended to deliver a mixture of granular reactive chemicals, suspended within a carrier fluid to an in situ area of contaminated soil and groundwater without significant dissolution of the reactive granules before injection into the subsurface.

In U.S. Pat. No. 5,525,008 organic contaminants in soil and ground-water are treated by injecting calculated amounts of a metallic salt solution with hydrogen peroxide under pressure.

U.S. Pat. No. 6,268,205 discloses a method for treatment of decontaminated soil and/or groundwater by injection of a slurry, immediately after mixing, of water and a powdered mixture of metallic peroxides into the soil. Decomposition rate modifiers, which are not specified, can be included in the powder mixture for controlling the reaction rate of peroxide with water.

The hydrogen peroxide is converted to a powerful oxidant (a hydroxyl radical), which in turn reacts with and oxidises the organic carbon in the treated media and the reaction chemistry is well documented for many types of contaminants. The reaction products obtained from the hydrogen peroxide reaction process are only carbon dioxide and water.

However, in an aqueous solution hydrogen peroxide is a very strong oxidation agent which is rapidly decomposed. The decomposition is catalyzed by wide variety of substances. Several transition metals and compounds thereof as well as organic substances are especially active. The same effect is obtained with substances having a large contact surface. Such a surface catalyzed decomposition of hydrogen peroxide may in a subsurface environment result in oxygen formation and potentially to an abiotic oxidation of organic contaminants. Thus, in practice such a use of aqueous solutions of hydrogen peroxide is prevented by the decomposition taking place before the actual decontamination effect of hydrogen peroxide can be utilized. The hydrogen peroxide will directly start to rapidly decompose when contacting the surface of the soil material and the oxidising effect will be considerably reduced.

It is also known that in highly contaminated systems (where the potential for unproductive side-reactions are great), H₂O₂ efficiently is improved by performing the oxidation either in a step wise fashion or, optimally, in a slow, continuous mode—as opposed to adding the aqueous solution of H₂O₂ all at the same time.

### SUMMARY OF THE INVENTION

The purpose of the invention is to provide a new method of reducing or eliminating contaminants in soil or groundwater by means of an oxidising agent, said oxidation agent is allowed to react with said contaminants under controlled release conditions, said controlled release conditions are obtained by controlling the dissolution of at least one inorganic and/or organic coating applied onto said oxidation agent, whereby the above-mentioned problems are eliminated.

Another purpose of the invention is to provide such a method, whereby the decomposition of the oxidising agent does not result in the formation of toxic substances.

Still another purpose is to provide such a method, whereby the oxidising agent can be homogeneously distributed in the soil before the actual oxidation reaction of the contaminants therein takes place.

Still further another purpose is to provide such a method, whereby the oxidation agent is applied directly with the same result as in a stepwise mode or in a slow, continuous mode.

These and other objects are accomplished by the method and use as claimed in claim 1 and 21, respectively.

### DETAILED DESCRIPTION OF THE INVENTION

According to the invention a method of in situ or ex situ reducing or eliminating contaminants in soil or groundwater is provided, in which solid particles of an oxidation agent are supplied to said soil or groundwater and dissolved in water, said oxidation agent is allowed to react with said contaminants under controlled release conditions, said controlled release conditions are obtained by controlling the dissolution of at least one inorganic and/or organic coating applied onto said oxidation agent.

The oxidation agent is preferably crystalline sodium carbonate peroxyhydrate.

Sodium carbonate peroxyhydrate is a so-called addition product, in which the hydrogen peroxide is quite loosely bonded, and this addition structure is partly responsible for its instability. It does not comprise any group, which corresponds to the structure of actual per-compounds, as do, for example, sodium perborate, sodium monopersulfate, or alkali persulfates. Sodium carbonate peroxyhydrate is also known by the names sodium percarbonate, sodium carbonate sesqui (peroxyhydrate), and sodium carbonate peroxide. It is considered environmentally friendly since its decomposition products do not pollute the environment.

Sodium percarbonate is well-known a bleaching or oxidising agent which has been used for bleaching, textile, pulp and paper, dental, cosmetic, hair, or medicinal purposes. It has mainly been used as the bleaching component in washing, bleaching and cleaning agents in powder form. It is highly soluble in water and is characterized by a rapid liberation of hydrogen peroxide.

The controlled release conditions can be obtained in that the dissolution is controlled by adjusting the crystal size and/or the crystal form of the crystalline sodium carbonate peroxyhydrate, the solid particles being an agglomerate of crystals.

The form of the crystalline sodium carbonate peroxyhydrate can be a monocrystal in the form of a hexagonal prism with a density of between 0.9 and 1 g/cm³, a mono-crystal in the form of a regular rhombohedral, a hollow granule with an apparent density of about 0.4 g/cm³ and with an average diameter of about 480 μm, or in the form of a compact grain with an average particle size of about 450 μm.

Preferably, the crystal size is between about 1 μm and about 100 μm, most preferred between about 5 μm and about 20 μm.

The solid particles, as agglomerates of crystals to be coated according to the invention, should have a particle size from about 150 μm to about 1500 μm, preferably from about 450 μm to about 1000 μm, most preferred from about 600 μm to about 800 μm. Such particles should have an apparent density of more than about 0.6 g/cm³, preferably from about 0.75 g/cm³ to about 1.1 g/cm³. Coated as well as non-coated particles should have an average bulk density between 0.5 and 0.6 g/cm³.

The average diameter of the sodium carbonate peroxyhydrate particles to be coated is generally 100 to 2000 μm, preferably 200 to 1500 μm and in particular 250 to 1000 μm. Commercial preparations are available-with an average particle size of about 500 μm.

The active oxygen content of the crystalline sodium carbonate peroxyhydrate particles should be as close to the theoretical active oxygen content of 15.28 weight % as possible, such as between 13.5 and 14.5% by weight. However, lower amounts of available oxygen may be an advantage in especial applications.

The coatings can comprise various additives in a wide range of proportions and in accordance with known teachings and/or practice. Such additives include, amongst others, persalt stabilisers, crystal habit modifiers and salting out agents.

The inorganic coating can be an alkali metal salt, an alkaline earth metal salt or another non-heavy metal salt of an organic or inorganic acid, alone or a combination thereof.

The least one inorganic coating is an alkali metal salt, an alkaline earth metal salt or another non-heavy metal salt of an organic or inorganic acid, alone or a combination thereof.

Examples of inorganic coatings are sodium carbonate, sodium bicarbonate, sodium sulphate, silicates, borates, perborates, boric acids, silicate-silicofluoride mixtures, and alkaline earth metal salts, etc.

Suitable coatings are alkali metal silicates, for example potassium silicate, sodium silicate, sodium metasilicate, sodium orthosilicate, sodium sesquisilicate and mixtures of two or more thereof.

The coating can also comprise a borate, such as dehydrated sodium perborate, dehydrated sodium perborate and sodium silicate, a borate-silicate mixture, a mixture of boric acid or borate and a water repellent agent, a borate-magnesium compound mixture. The borate is preferably a sodium salt of boric acid, such as sodium tetraborate decahydrate (or borax), sodium tetraborate pentahydrate, sodium tetraborate tetrahydrate, sodium tetraborate anhydrate, sodium octaborate tetrahydrate, sodium pentaborate pentahydrate, sodium metaborate tetrahydrate and sodium metaborate dihydrate, especially preferably sodium metaborate dihydrate or sodium metaborate tetrahydrate.

Combinations of alkali metal silicates and borates also increase the mechanical strength of the coating.

Salts of phosphoric acids, such as orthophosphoric, pyrophosphoric, tripolyphosphoric, metaphosphoric, hexametaphosphoric or phytic acid, can also be used.

Other examples of coatings are salts of phosphonic acids, such as ethane-1,1-diphosphonic, ethane-1,2-triphosphonic, or ethane-1-hydroxy-1,1-diphosphonic acid and derivatives thereof, ethane-hydroxy-1,1,2-triphosphonic, ethane-1,2-dicarboxy-1,2-diphosphonic, or methane-hydroxyphosphonic acid, as well as salts of phosphonocarboxylic acids, such as 2-phosphonobutane-1,2-dicarboxylic, 1-phosphonobutane-2,3,4-tricarboxylic and α-methylphosphonosuccinic acid, or salts of amino acids, such as aspartic or glutamic acid or a silicate-glycine mixture.

Examples of inorganic coatings are salts of organic acids, such as diglycolic, hydroxydiglycolic, carboxymethyloxysuccinic, cyclopentane-1,2,3,4-tetracarboxylic, tetrahydrofuran-1,2,3,4-tetracarboxylic, tetrahydrofuran-2,2,5,5-tetracarboxylic, citric, lactic or tartaric acid, carboxymethylated products of sucrose, lactose or raffinose, carboxymethylated pentaerythritol, carboxymethylated gluconic acid, condensates of polyhydric alcohols or sugars with maleic or succinic anhydride, condensates of hydroxycarboxylic acids with maleic or succinic anhydride, benzenepolycarboxylic acids such as mellitic acid, ethane-1,1,2,2-tetracarboxylic, ethene-1,1,2,2-tetracarboxylic, butane-1,2,3,4-tetracarboxylic, propane-1,2,3-tricarboxylic, butane-1,4-dicarboxylic, oxalic, sulfosuccinic, decane-1,10-dicarboxylic, sulfotricarbollylic, sulfoitaconic, malic, hydroxydisuccinic or gluconic acid.

Other organic and/or polymer compounds are waxs, a latexes, paraffins, polyols, vinyl resins, polyethylene glycols, polyvinyl alcohols, and polyvinylpyrrolidone. Suitgable coatings are polyacrylic acid, polyaconitic acid, polyitaconic acid, polycitraconic acid, polyfumaric acid, polymaleic acid, polymesaconic acid, poly-α-hydroxyacrylic acid, polyvinylphosphonic acid, sulfonated polymaleic acid, maleic anhydride/diisobutylene polymers, maleic anhydride/styrene polymers, maleic anhydride/methyl vinyl ether polymers, maleic anhydride/ethylene polymers, maleic anhydride/ethylene cross-linked polymers, maleic anhydride/vinyl acetate polymers, maleic anhydride/acrylonitrile polymers, maleic anhydride/acrylate polymers, maleic anhydride/butadiene polymers, maleic anhydride/isoprene polymers, poly-β-ketocarboxylic acid derived from maleic anhydride and carbon monoxide, itaconic acid/ethylene polymers, itaconic acid/aconitic acid polymers, itaconic acid/maleic acid polymers, itaconic acid/acrylic acid polymers, malonic acid/methylene polymers, mesaconic acid/fumaric acid polymers, ethylene glycol/ethylene terephthalate polymers, vinylpyrrolidone/vinyl acetate polymers, 1-butene-2,3,4-tricarboxylic acid/itaconic acid/acrylic acid polymers, polyester polyaldehyde carboxylic acid containing a quaternary ammonium group, cis-isomer of epoxysuccinic acid, poly[N,N-bis(carboxymethyl)acrylamide], poly(oxycarboxylic acids), starch succinate, maleate or terephthalate, starch phosphate, dicarboxystarch, dicarboxymethylstarch and cellulose succinate.

The controlled release conditions can be improved by including a controlled release retarder in the at least one coating and/or by adding the same together with the solid particles to the soil or groundwater. The controlled release retarder can be a metal chelating agent, or an antioxidant, alone or a combination thereof.

Examples of suitable retarders are salts of aminopolyacetic acids, such as nitrilotriacetic, ethylenediaminetetraacetic or diethylenetriaminepentaacetic acid, nitrilotriacetate and the phosphate, and ascorbic acid.

Likewise, the controlled release conditions can be improved in that the dissolution of the least one coating is controlled by including a controlled release accelerator in the at least one coating and/or by adding the same together with the solid particles to the soil or groundwater. The controlled release accelerator can be a a transition element or another non-heavy metal, or a peroxidase, alone or a combination thereof.

The controlled release conditions can also be improved in that the dissolution of the at least one coating is controlled by adjusting the thickness of the at least one coating. The thickness of the coating depends on the specific application and should under normal circumstances have a thickness between 5 μm and 30 μm.

The solid particles of crystalline sodium carbonate peroxyhydrate can be used in situ as well as ex situ.

When used in situ, solid particles are added the soil via a dosage pipe which can be installed by means of guidable horizontal drilling. In this way tubes etc can be installed in order to reach far contaminants below deposits, buildings, parking places, lakes, rivers, etc, without the normal activity being disturbed. Preferably, the solid particles are injected in situ to the soil by the same or a similar process as when lime-cement columns are installed, a common method in Scandinavia of deep stabilization of cohesive soils, the soils being reinforced with lime or lime/cement columns. In this way the particles can be delivered at the required depth by means of vertical drilling and ejecting the same by using air pressure.

The water required for dissolution and transport of the solid particles comprising crystalline sodium carbonate peroxyhydrate to the contanimants is either existing and running ground water or machanically injected water.

When added ex situ to the soil, mechanical mixing can be used. Alternatively, the solid particles are added by means of sprinkling onto the soil on for example a conveyor. In this way a homogenous distribution of the solid crystalline sodium carbonate peroxyhydrate particles can be obtained prior to the chemical oxidation reaction. The soil can be deposited in heaps for reaction and subsequent analysis.

In either case, the controlled release conditions are further obtained in that the dissolution of the at least one coating is controlled by mechanically injecting or spraying additional water into or onto the soil, respectively.

Likewise, the release conditions can be further controlled in that the dissolution of the at least one coating by heating the soil or groundwater and/or the solid particles while adding the same. Both the oxidizing reaction and the reaction in which the salt is dissolved are exothermic, which further controls the release conditions.

Tests have been made on the possible difference in efficiency between sequential and direct application of the solid particles comprising crystalline sodium carbonate peroxyhydrate, and the results show that no such difference exists.

The dosage of the oxidation agent in the inventive method, for degradation of contaminants in soil is mostly based on experience. Theoretically, the consumption of the oxidation agent can be calculated, but in practice a lot of factors affect this consumption. For example, the level of catalytic metals (iron, copper and others) have a big influence on the course of events in soil.

For contaminants the unit —CH₂— can be used as average formula. In this case a reaction with hydrogen peroxide is

Reaction: CH₂+3 H₂O₂ [symbol] CO₂+4 H₂O MW, g/mol: 14.03 34.01

Thus 14.03 g contaminant consumes 3*34.01=102.03 g H₂O₂, which corresponds to a theoretical consumption of 7.27 g H₂O₂ per 1 g of contaminant. The level (which can be controlled during manufacturing of the solid particles) of H₂O₂ produced by the oxidation agent should for example be between 10 and 80 weight %, preferably between 15 and 65 weight %, more preferably between 20 and 55 weight %, most preferably between 25 and 40 weight %. For example, an amount of 30 weight % corresponds to 1 g of a contaminant, which demands 24.23 g of a H₂O₂ producing oxidation agent.

### EXAMPLES

The invention will now be further described and illustrated by reference to the following examples. It should be noted, however, that these examples should not be construed as limiting the invention in any way.

### Example 1

The utility of the invention method was evaluated by measuring the decomposition of hydrogen peroxide from solid particles of sodium carbonate peroxyhydrate crystals having a coating of sodium sulphate thereon. The thickness of the coating was about 0.02 mm and the total diameter of the particles was about 1.5 mm. These particles were mixed (50:50 by weight) with zeolite, Wessalith P (4A), which was used as a substitute for soil. The dry mixture was stored in a climate chamber with a temperature of 30° C. and a relative humidity of 70%. After 0, 1, 2, 4, 6, 8 and 12 weeks, samples of 5 g were removed and the hydrogen peroxide content was analysed by titration with potassium permanganate according to LPU-01.

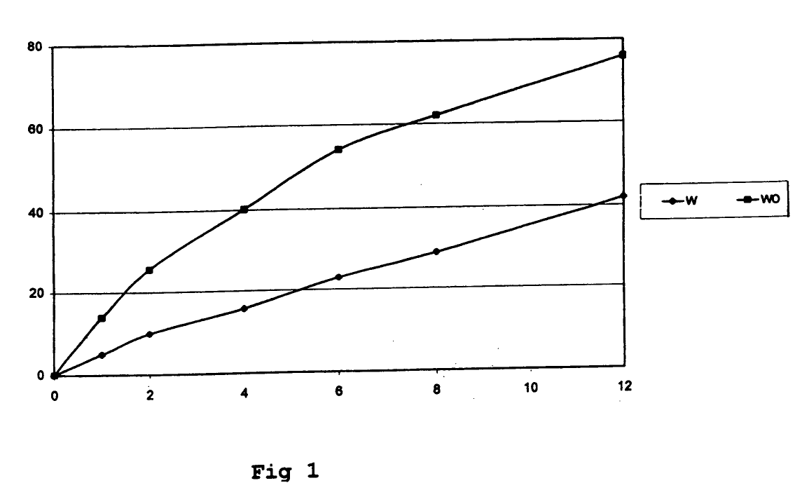

FIG. 1 shows a diagram of the decomposition (y-axis), in %, of solid particles with (W) and without (WO) coating, 50% sodium carbonate peroxyhydrate+50% zeolite, temp. 30° C., 70% R.H., wherein time (x-axis) is in weeks.

The low decomposition rate of particles, having a coating thereon provides a longer active oxygen treatment in the soil. This is a benefit compared with a rapid active oxygen release, when all the active oxygen does not have time to react with contaminants in the soil.

### Example 2

Two approaches of mixing were investigated, each comprising 20 kg of soil material (see Table 1) and the same amount of the oxidation agent particles. The solid particles used were the same as in example 1.

A petroleum contaminated soil from an industrial site was used as a matrix material in tests, which comprised sand and 0.5% (dry weight) organic substances, analyzed as loss on ignition (LOI) at 550° C.

Half of the organic content was estimated to consist of petroleum products, with enhanced levels of non-polar aliphatic compounds of a quality indicating diesel oil contamination. The remaining part of the organic content in the soil we considered to be naturally occurring substances. Table 1 below shows the main parameters studied and their levels, as determined by means of the method used.

TABLE 1

| | | Number of | | |
|---|---|---|---|---|
| Parameter | Method | samples | Levels* | |
| Soil | Visual | 5 | Sand | — |
| | judgement | | | |
| DM¹⁾ | SS 028113 | 5 | 88 | % by weight |
| TOC²⁾ | Calculated | 5 | 0.5 | % of DM |
| | from LOI | | | |
| Total non-polar | SS 028145-4 | 2 | 3119 | mg/kg DM |
| alifatics | | | | |
| Benzene | GC-MS | 2 | <0.05 | mg/kg DM |
| Toluen | GC-MS | 2 | <0.05 | mg/kg DM |
| Ethyl benzene | GC-MS | 2 | <0.05 | mg/kg DM |
| Total xylenes | GC-MS | 2 | <0.05 | mg/kg DM |
| Alifatics | GC-MS | 2 | <10 | mg/kg DM |
| (>C5-C8) | | | | |
| Alifatics | GC-MS | 2 | <10 | mg/kg DM |
| (>C8-C10) | | | | |
| Alifatics | GC-FID | 2 | 410 | mg/kg DM |
| (>C10-C12) | | | | |
| Alifatics | GC-FID | 2 | 1689 | mg/kg DM |
| (>C12-C15) | | | | |
| Alifatics | GC-FID | 2 | 2353 | mg/kg DM |
| (>C16-C35) | | | | |

*Average
¹⁾Dry matter
²⁾Total organic content

Intermixing of the oxidation agent of the present invention in one of the approaches (A) was performed momentary at one occasion and under mixing. The intermixing of the oxidation agent of the present invention in the second approach (B) was performed at four repeated occasions, in a three day interval. At every intermixing occasion (B) one fourth of total volume of the oxidation agent in the present invention was added. A mixed sample is taken out from each of the two different approaches on day 1, 3, 6, 10, and 12, and is analyzed with regard to the total amount of non-polar alifatic substances. In one fraction (Reference) no oxidation agent of the present invention is added and the fraction (Reference) is handled in the same way, with repeated intermixing, as the fractions with the oxidation agent of the present invention. The results are shown in Table 2 below, which shows the reduction of total non-polar alifatics (in %)

TABLE 2

| Experiment | Day 1 | Day 3 | Day 6 | Day 10 | Day 12 |
|---|---|---|---|---|---|
| Reference | — | 10 | 24 | 33 | 32 |
| A | 58 | 71 | — | — | — |
| B | — | 51 | 58 | 62 | 71 |

### Example 3

The study comprises a volume of 150 tons soil material in total, where the dosage of the oxidation agent of the present invention was made in a mixing barrel. During intermixing, water was also added to get as close as possible to the optimal moisture level in the soil. It appeared that the physically most suitable level of moisture for slow dissolution of the oxidation agent in the method of the present invention should be about 85% DM. After dosage of the oxidation agent, samples were taken from the soil material, which were analyzed with respect to non-polar alifatics and aromatics. Results are shown in Table 3 below.

TABLE 3

| Parameter | Samples | Level | Dev.² | Unit | Reduction¹ | Dev.² | Unit |
|---|---|---|---|---|---|---|---|
| Tot. non-pol. | 10 | 951 | +/−97 | mg/kg DM | 69 | +/−4 | % |
| Alifatics | | | | | | | |
| Benzene | 2 | <0.05 | — | mg/kg DM | — | — | — |
| Toluene | 2 | <0.05 | — | mg/kg DM | — | — | — |
| Ethyl Benzene | 2 | <0.05 | — | mg/kg DM | — | — | — |
| Tot. Xylenes | 2 | <0.05 | — | mg/kg DM | — | — | — |
| Alifatics | 2 | <10 | — | mg/kg DM | — | — | — |
| (>C5-C8) | | | | | | | |
| Alifatics | 2 | <10 | — | mg/kg DM | — | — | — |
| (>C8-C10) | | | | | | | |
| Alifatics | 2 | 180 (130)³ | — | mg/kg DM | 56 | — | % |
| (>C10-C12) | | | | | | | |
| Alifatics | 2 | 605 (460)³ | — | mg/kg DM | 64 | — | % |
| (>C12-C16) | | | | | | | |
| Alifatics | 2 | 850 (690)³ | — | mg/kg DM | 64 | — | % |
| (>C16-C35) | | | | | | | |

¹Average
²95% confidence interval
³2 months after dosage

The chemical oxidation with hydrogen peroxide is an exoterm reaction and brings about an increase in temperature in surrounding material. Furthermore, the increase in temperature can even be correlated with the physical process that take place when salts of sodium carbonate take up water (crystal water). Accordingly, the increase in temperature is accordingly a measure of that the oxidation agent in the inventive method is dissolved and that hydrogen peroxide is liberated. The temperature was studied during and after the application of the oxidation agent. The results are shown in Table 4 below.

To prevent leavage of hydrogen carbons to the atmosphere, the surface of the laid out, ready-mixed soil was covered with a thin layer of wood bark, which acts as a absorbant. The relative amount of hydrogen carbons, which may be formed during the treatment and liberated to the environment, was monitored consecutively with a portable equipment, a photo ionization detector—PID, for determination of volatile hydrogen carbons. The results are shown in Table 4 below.

TABLE 4

| | Time/ | Temp. | PID/ | |
|---|---|---|---|---|
| Time/h | days | ° C. | ppm* | Comment |
| 0.00 | 0.00 | 20 | 350 | Temperature at start |
| 0.25 | 0.01 | 25 | — | |
| 1.00 | 0.04 | 38 | 400 | |
| 1.75 | 0.07 | 53 | 300 | |
| 2.50 | 0.10 | 59 | 360 | |
| 2.67 | 0.11 | 60 | 367 | Maximum temperature |
| 3.00 | 0.13 | 56 | — | |
| 3.50 | 0.15 | 56 | — | |
| 4.00 | 0.17 | 56 | — | |
| 13.25 | 0.55 | 37 | — | ½ max. temp. after ½ day |
| 37.25 | 1.55 | 29 | — | |
| 61.25 | 2.55 | 20 | — | Back to start temp. after 2.5 days |

*The measurement was made at constant temperature

Originally 450 kg contaminants were present in the soil and after treatment 310 kg of them was eliminated, which corresponds to a level of reduction of 69±4%. The result from the laboratory experiment show that a further degradation of alifatics is obtained with an elevated dosage of the oxidation agent in the method of the present invention.

Volatile contamination from stored piles of petroleum contaminated soil was minimized by covering the piles with an absorbent (bark) directly after mixing.

Furthermore, it can be established that the levels of short alifatic fractions (defined by the analysis methods GC-FID/MS, IR SS028145-4) do not increase after degradation, and that the value from PID measurement of volatile organic substances does not increase. The chemical process does therefore not contribute to any substantial degree to the liberation of contaminants to the environment. Those alifatics which react with hydrogen peroxide are probably completely degraded and do consequently result in water and carbon dioxide.

The optimal moisture content in the soil was determined in order to obtain an effective dissolution of the oxidation agent in the inventive method. The moisture content does not only affect how fast the oxidation agent in the present invention is dissolved, but also the mobility of the hydrogen peroxide released. This study shows that 85% DM is an optimal level. If the moisture content was altered to 80 and 90% DM, respectively, the reduction of contaminants was decreased by approximately 30%.

The degradation of contaminants does mainly occur during the first couple of days, and during this process an increase of temperature in the material is denoted. Consequently, during dosage of hydrogen peroxide, the monitoring of the temperature constitute an easy control parameter for the chemical oxidation of contaminants in soil. This parameter can be used to continuously control and optimize the chemical degradation process.

In summary the method according to the present invention acts satisfactory for oxidation of petroleum constituents in tested piles. The method is easy to apply in field and the chemical process is fast. Handling of contaminated soil, from an environmental and health point of view, may be minimized. Since the contaminants are degraded fast and are eliminated, in course of time, a long and hazardous handling of harmful piles of soil may be avoided. The decontaminated soil has not been recontaminated by additional additives, which is a positive characteristic, from an environmental and health point of view.

1-29. (canceled)

30. A method of in situ or ex situ reducing or eliminating contaminants in soil or groundwater, in which solid particles of an oxidation agent are supplied to said soil or groundwater and dissolved in water, said oxidation agent is allowed to react with said contaminants under controlled release conditions, wherein said controlled release conditions are obtained by controlling the dissolution of at least one inorganic and/or organic coating applied onto said oxidation agent.

31. The method as in claim 30, wherein said dissolution is controlled by adjusting the thickness of said at least one inorganic and/or organic coating.

32. The method as in claim 30, wherein said controlled release conditions are controlled by adjusting the size of said particles.

33. The method as in claim 30, wherein said controlled release conditions are controlled by adjusting the crystal size and/or the crystal form of said oxidation agent.

34. The method as in claim 30, wherein said controlled release conditions are obtained by supplying, together with said solid particles, a controlled release retarder to said soil or groundwater.

35. The method as in claim 30, wherein said controlled release conditions are obtained by including said controlled release retarder in said at least one coating.

36. The method as in claim 34, wherein said controlled release retarder is a metal chelating agent, or an antioxidant, or a combination thereof.

37. The method as in claim 30, wherein said controlled release conditions are obtained by supplying, together with said solid particles, a controlled release accelerator to said soil or groundwater.

38. The method as in claim 30, wherein said controlled release conditions are obtained by including a controlled release accelerator in said at least one coating.

39. The method as in claim 37, wherein said controlled release accelerator is a transition element or another non-heavy metal, or a peroxidase, or a combination thereof.

40. The method as in claim 30, wherein said controlled release conditions are obtained by mechanically injecting or spraying additional water into or onto said soil, respectively.

41. The method as in claims 30, wherein said controlled release conditions are obtained by heating said soil or groundwater and/or said solid particles while adding the same.

42. The method as in claim 30, wherein said oxidation agent is sodium carbonate peroxyhydrate.

43. The method as in claim 30, wherein said solid particles are added in situ to said soil via a dosage pipe.

44. The method as in claim 43, wherein said dosage pipe is installed by means of guidable horizontal drilling.

45. The method as in claim 30, wherein said solid particles are added ex situ to said soil by means of mechanical mixing.

46. The method as in claim 30, wherein said solid particles are added ex situ by means of sprinkling onto said soil.

47. The method as in claim 30, wherein said at least one coating has a thickness between 5 μm and 30 μm.

48. The method as in claim 30, wherein said solid particles has a size between 250 μm and 1000 μm.

49. The method as in claim 30, wherein said solid particles has an average bulk density between 0.5 and 0.6 g/cm³.

50. Use of solid particles of an oxidation agent as an active component for reducing or eliminating contaminants in soil or groundwater, said solid particles having at least one inorganic and/or organic coating.

51. Use as in claim 50, wherein said at least one organic coating is a wax, a latex, a polyol, or a vinyl resin.

52. Use as in claim 50, wherein said solid particles having a controlled release retarder incorporated in said at least one inorganic and/or organic coating.

53. Use as in claim 50, wherein said controlled release retarder is a metal chelating agent, or an antioxidant, alone or a combination thereof.

54. Use as in claim 50, wherein said solid particles having a controlled release accelerator incorporated in said at least one inorganic and/or organic coating.

55. Use as in claim 50, wherein said controlled release accelerator is a transition element or another non-heavy metal, or a peroxidase, alone or a combination thereof.

56. Use as in claim 50, wherein said at least one inorganic and/or organic coating has a thickness between 5 μm and 30 μm.

57. Use as in claim 50, wherein said solid particles has a size between 250 μm and 1000 μm.

58. Use as in claim 50, wherein said solid particles has an average bulk density between 0.5 and 0.6 g/cm³.
